(19) United States
(12) Patent Application Publication
(10) Pub. No.: US 2016/0248112 A1
(43) Pub. Date: Aug. 25, 2016

(54) FUEL CELL WITH OPTIMISED OPERATION ALONG THE AIR FLOW CHANNEL

(71) Applicant: COMMISSARIAT À L'ÉNERGIE ATOMIQUE ET AUX ÉNERGIES ALTERNATIVES, Paris (FR)

(72) Inventors: Jeremy ALLIX, Grenoble (FR); Lara JABBOUR, Grenoble (FR); Jean-Sebastien ROCH, Grenoble (FR); Remi VINCENT, Grenoble (FR)

(73) Assignee: COMMISSARIAT A L'ENERGIE ATOMIQUE ET AUX ENERGIES ALTERNATIVES, Paris (FR)

(21) Appl. No.: 15/032,932

(22) PCT Filed: Oct. 22, 2014
(86) PCT No.: PCT/FR2014/052683

§ 371 Date: Apr. 28, 2016

(30) Foreign Application Priority Data
Oct. 30, 2013 (FR) 1360644

(51) Int. Cl. H01M 8/1004; H01M 8/0247; H01M 8/1007

(52) U.S. Cl. CPC H01M 8/1004; H01M 8/1007; H01M 8/0247

(57) ABSTRACT

The invention relates to a fuel cell comprising: a membrane/electrodes assembly (111, 112, 113) comprising a cathode attached to a membrane; a conductive plate (102) defining a flow channel between an air inlet and a water outlet; and a gaseous diffusion layer subjected to compression between the cathode (112) and the conductive plate (102), and comprising first and second parts (24, 25) which are joined together, have different compositions and are of the same thickness beneath said compression, the first part extending by between 15 and 50% of the length of the channel from the air inlet and the second part extending by between 50 and 85% of the length of the channel from the water outlet.

The invention relates to fuel cell stacks, and in particular proton exchange membrane (PEM) fuel cell stacks.

Fuel cell stacks are envisioned as systems for supplying electricity to mass-produced automotive vehicles in the future, and for many other applications. A fuel cell stack is an electrochemical device that converts chemical energy directly into electrical power. Dihydrogen is used as fuel of the fuel cell stack. Dihydrogen is oxidized and ionized at an electrode of the stack and dioxygen from the air is reduced at another electrode of the stack. The chemical reaction produces water at the cathode, oxygen being reduced and reacting with the protons. The great advantage of the fuel cell stack is preventing releases of atmospheric pollutants at the electricity generation site.

Proton exchange membrane (PEM) fuel cell stacks have particularly advantageous properties of compactness. Each cell comprises an electrolytic membrane that allows only the passage of protons and not the passage of electrons. The membrane comprises an anode on a first face and a cathode on a second face in order to form a membrane electrode assembly (MEA).

At the anode, the dihydrogen is ionized in order to produce protons that pass through the membrane. The electrons produced by this reaction migrate toward a flow plate, then pass through an electrical circuit external to the cell in order to form an electric current. At the cathode, oxygen is reduced and reacts with the protons to form water.

The fuel cell stack may comprise several flow plates, for example made of metal, stacked on top of one another. The membrane is positioned between two flow plates. The flow plates may comprise flow channels and orifices in order to guide the reactants and the products to/from the membrane. The plates are also electrically conductive in order to form collectors for the electrons generated at the anode. Gas diffusion layers are inserted between the electrodes and the flow plates and are in contact with the flow plates.

The MEAs have a heterogeneous or non uniform operation over the length of the air and hydrogen flow channels. On the cathode side for example, the change in the relative humidity of the gases between the inlet (drying conditions) and the outlet (flooding conditions) of the flow channel has an effect on the heterogeneity of the current density. The current density is lower at the inlet of the flow channel due to an insufficient humidity. The current density is also lower at the outlet of the flow channel due to an excessive humidity that may flood the MEA. This heterogeneity of current density promotes degradation phenomena such as the localized corrosion of the carbon or the maturation of the catalyst.

Document US 2004/038808 describes a membrane electrode assembly structure. In this structure, the catalyst concentration of the cathode varies with a gradient along an axis. This document describes a homogeneous gas diffusion layer.

Document EP 1 176 654 describes a fuel cell stack structure in which a same electrode combines a catalytic layer and a gas diffusion layer, the properties of which vary in various zones.

Document U.S. Pat. No. 6,933,067 proposes producing a cathode having an increasing platinum loading from the air outlet up to the air inlet. Thus, a large amount of water is generated at the inlet of this flow channel in order to increase the current density thereof. Such a cathode is however relatively difficult to produce correctly on an industrial scale.

The invention aims to solve this drawback and to propose an alternative solution to this technical problem, while facilitating the precise positioning of a gas diffusion layer. The invention thus relates to a fuel cell stack as defined in the appended claims. The invention also relates to a process for manufacturing a fuel cell stack, as defined in the appended claims.

Other features and advantages of the invention will become clearly apparent from the description that is given thereof below, by way of nonlimiting illustration, and with reference to the appended figures, in which:

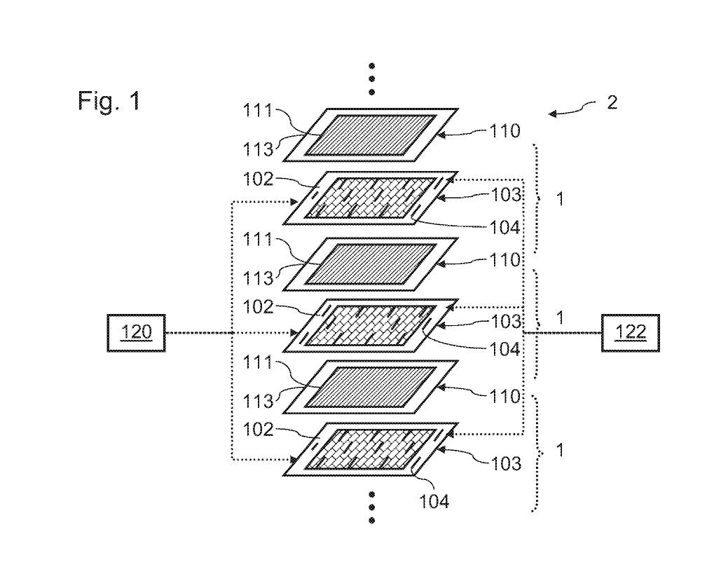

FIG. 1 is an exploded perspective view of an example of a fuel cell stack;

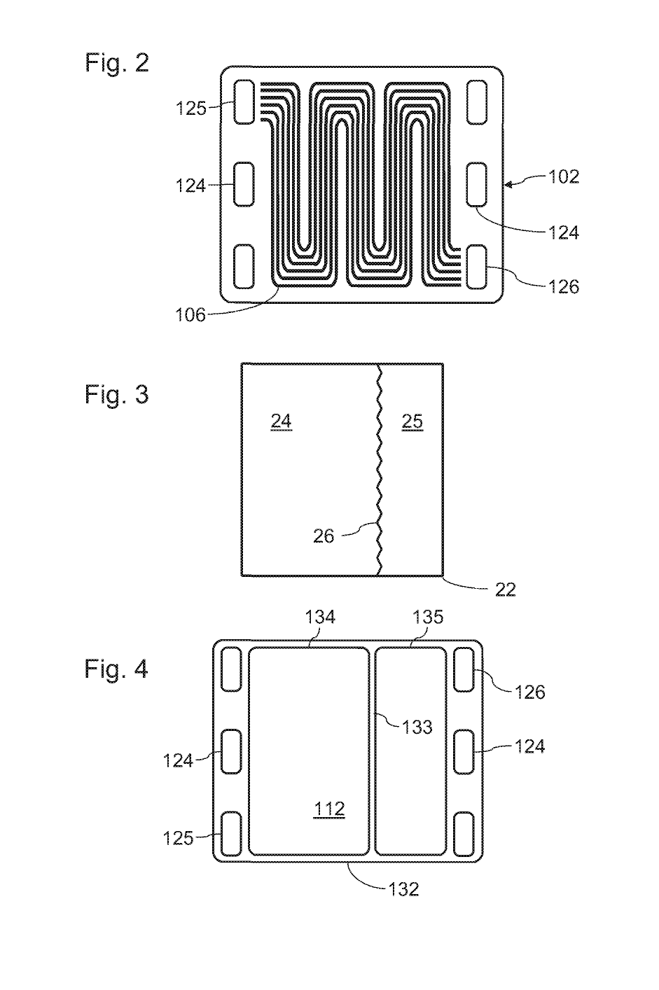

FIG. 2 is a top view of a flow plate comprising an example of a flow channel route;

FIG. 3 is a bottom view of a cathode gas diffusion layer according to one example of embodiment of the invention;

FIG. 4 is a bottom view of a membrane electrode assembly provided with a reinforcement, intended to be combined with the gas diffusion layer from FIG. 3;

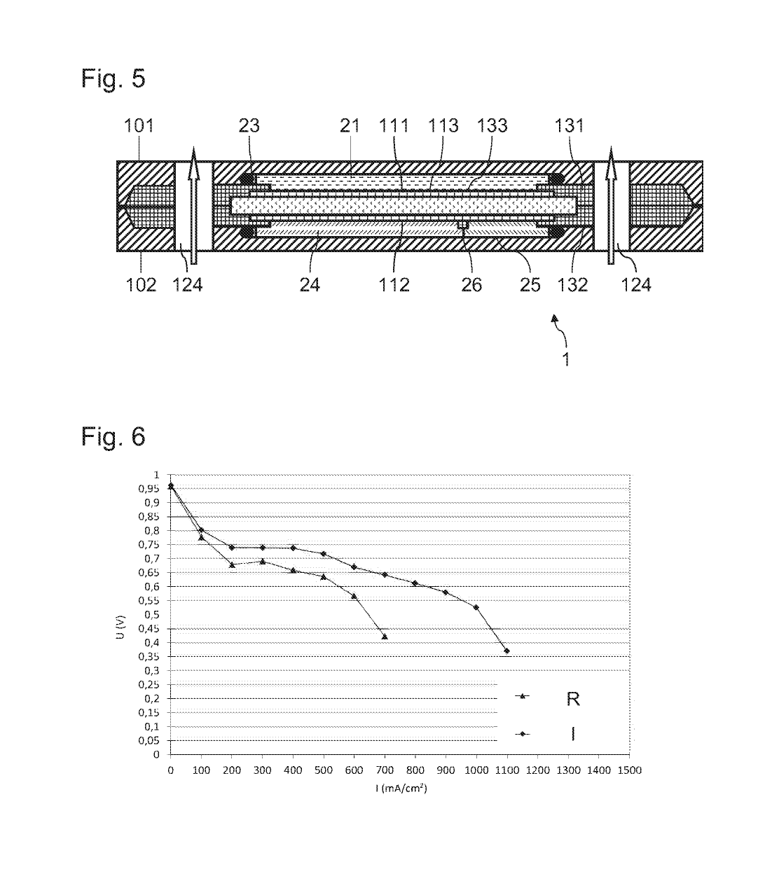

FIG. 5 is a cross-sectional view of one cell of a fuel cell stack according to one example of embodiment of the invention;

FIG. 6 is a graph illustrating the respective performances of a fuel cell stack according to the prior art and according to one embodiment of the invention;

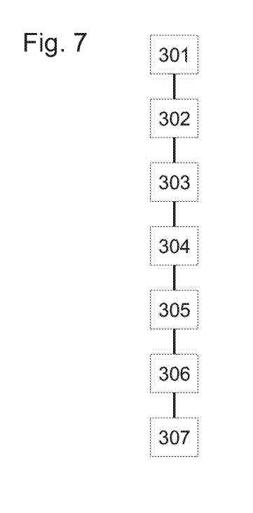

FIG. 7 illustrates a sequence of steps of an example of a manufacturing process according to the invention.

FIG. 1 is a schematic exploded perspective view of a stack of cells 1 of a 10 fuel cell stack 2. The fuel cell stack 2 comprises several superposed cells 1. The cells 1 are of proton exchange membrane or polymer electrolyte membrane type.

The fuel cell stack 2 comprises a fuel source 120 supplying an inlet of each cell 1 with dihydrogen. The fuel cell stack 2 also comprises an air source 122 supplying an inlet of each cell with air, containing oxygen used as oxidant. Each cell 1 15 also comprises exhaust channels. Each cell 1 may also have a cooling circuit (illustrated in FIG. 2).

Each cell 1 comprises a membrane electrode assembly 110. The fuel cell stack 2 illustrated especially comprises a number of membrane electrode assemblies or MEAs 110. A membrane electrode assembly 110 comprises an electrolyte 113, 20 cathode 112 (not illustrated in FIG. 1) and an anode 111 which are placed on either side of the electrolyte and fastened to this electrolyte 113.

Between each pair of adjacent MEAs, a pair of flow guides is positioned. The flow guides of each pair are firmly attached in order to form a bipolar plate 103. Each flow guide is for example formed from a metal sheet, usually made of stainless steel. 25 A bipolar plate 103 thus comprises a metal sheet 102 oriented toward a cathode of an MEA 110 and a metal sheet 101 (not illustrated in FIG. 1) oriented toward an anode of another MEA 110. The metal sheets 101 and 102 have surfaces in relief defining flow channels 106 (not illustrated in FIG. 1). The metal sheets 101 and 102 are firmly attached by welds 104.

In a manner known per se, during the operation of the cell 1, air flows between the MEA and the metal sheet 102, and dihydrogen flows between the MEA and the metal sheet 101. At the anode 111, the dihydrogen is ionized in order to produce protons that pass through the MEA. The electrons produced by this reaction are collected by the metal sheet 102. The electrons produced are then applied to an electrical load connected to the fuel cell stack 2 in order to form an electric current. At the cathode 112, oxygen is reduced and reacts with the protons in order to form water. The reactions at the anode and the cathode are governed as follows:

H₂→2H⁺+2e⁻ at the anode;

4H⁺+4e+O₂→2H₂O at the cathode.

During its operation, one cell of the fuel cell stack usually generates a DC voltage between the anode and the cathode of the order of 1 V. The catalyst material used at the anode 111 or at the cathode 112 is advantageously platinum, for its excellent catalytic performance.

FIG. 2 is a top view of an example of a metal sheet 102 of a fuel cell stack 2. The metal sheet 102 delimits flow channels 106. The flow channels 106 extend between an air inlet duct 125 and a water outlet duct 126. The metal sheet 102 is furthermore passed through by a coolant flow duct 124.

FIG. 3 is a bottom view of an example of a gas diffusion layer 22 placed in contact with the metal sheet 102 and covering the flow channels 106. The gas diffusion layer 22 comprises a first portion 24 and a second portion 25. The first portion 24 covers a portion of the flow channels 106 from the air inlet 125. The second portion covers a portion of the flow channels 106 from the water outlet 126.

The portions 24 and 25 of the gas diffusion layer 22 are adjoining. The portions 24 and 25 are here two separate components, that adjoin at an interface 26. The portions 24 and 25 are advantageously adjoining without overlapping, in order to avoid forming an overthickness at the interface 26.

The portions 24 and 25 have different compositions. Thus, the composition of the portion 24 has a current density under dry conditions greater than that of the composition of the portion 25. The portion 24 thus makes it possible to obtain a greater current density in the vicinity of the air inlet, at the start of the flow channel 106, under drying conditions when only a little water has been generated in the flow channel 106. The portion 24 extends for example between 15 and 50% of the length of the flow channel 106 from the air inlet. The composition of the portion 25 has a current density under wet conditions greater than that of the composition of the portion 24. The portion 25 extends for example between 50 and 85% of the length of the flow channel 106 From the water outlet. The median portion of the flow channel 106, in which the humidity level is intermediate, thus benefits from the composition of the portion 25.

A person skilled in the art will be able to determine more precisely the distribution of the portions 24 and 25 over the length of the flow channel 106 with an acquisition card for acquiring the localized currents that is positioned in the stack of the cells 1, with a prior test on a uniform gas diffusion layer 21. Such a card makes it possible in particular to determine the zones in which the current density is lower, in order to determine up to where the portion 25 should extend.

Tests have in particular been carried out with a current acquisition card having a 20×24 matrix, each element of the matrix having a surface area of 0.45 cm².

The portion 24 may be formed from a gas diffusion layer sold by Freudenberg FCCT under the commercial reference H2 415-I2-C3. The portion 25 may be formed from a gas diffusion layer sold by SGL Group under the commercial reference 24BC. FIG. 6 is a graph that compares the respective polarization curves of fuel cell stacks R and I. The fuel cell stack R includes a gas diffusion layer consisting solely, and as 20 one piece, of the layer sold by SGL Group under the commercial reference 24BC. The fuel cell stack I includes a gas diffusion layer having a portion 24 of Freudenberg H2 415-I2-C3 type and a portion 25 of SGL Group 24BC type. A substantial increase in the average current density and a homogenization of this density are noted irrespective of the operating conditions.

The dry conditions are for example determined for a relative humidity of 20%. The wet conditions are for example determined for a relative humidity of 100%.

In order to facilitate a satisfactory positioning between the first and second portions 24 and 25, these advantageously have adjoining edges of complementary and non-rectilinear shapes, as illustrated in the example from FIG. 3.

FIG. 4 is a bottom view of an example of a reinforcement 132 that proves particularly advantageous within the context of the invention. The reinforcement 132 is fastened to a membrane electrode assembly 103. The reinforcement 132 comprises a first median opening 134 and a second median opening 135. These median openings 134 and 135 are separated by a strip 133. The median openings 134 and 135 reveal a portion of the cathode 112. The reinforcement 132 is additionally passed through by the air inlet duct 125, by the water outlet duct 126 and by the coolant flow duct.

FIG. 5 is a cross-sectional view of one cell 1 of the assembled fuel cell stack 2.

A reinforcement 131 is fastened to the membrane electrode assembly. The reinforcement 131 comprises an inner edge which covers the periphery of the anode 111. The inner edge is firmly attached to the anode 111. The reinforcement 131 extends beyond the periphery of the anode 111 and forms an overlap on the membrane 113. The reinforcement 131 is firmly attached to the membrane 113. The firm attachment of the reinforcement 131 to the anode 111 and to the membrane 113 may be achieved by any suitable means, for example by hot pressing or by printing of the anode 111 on the reinforcement 131. The reinforcement 131 comprises a median opening. This median opening reveals the median portion of the anode 111.

The gas diffusion layer 21 is compressed between the anode 111 and the metal sheet 101. The gas diffusion layer 21 thus crosses the median opening of the reinforcement 131 and is in contact with the anode 111.

The reinforcement 132 is fastened to the membrane electrode assembly and to the reinforcement 131. The reinforcement 132 comprises inner edges which cover the periphery of the cathode 112. The inner edges are firmly attached to the cathode 112. The reinforcement 132 extends beyond the periphery of the cathode 112 and forms an overlap on the membrane 113. The reinforcement 132 is firmly attached to the membrane 113. The reinforcements 131 and 132 are fastened to one another at their periphery.

The portion 24 of the gas diffusion layer 22 is compressed between the cathode 112 and the metal sheet 102. The portion 24 thus crosses the median opening 134 of the reinforcement 132 and is in contact with the cathode 112. The portion 25 of the gas diffusion layer 22 is compressed between the cathode 112 and the metal sheet 102. The portion 25 thus crosses the median opening 135 of the reinforcement 132 and is in contact with the cathode 112. The interface 26 between the portions 24 and 25 is superposed on the strip 133 separating the openings 134 and 135. The risk of asperities potentially present at the edges of the portions 24 and 25 impairing or even piercing the cathode 112 or the membrane 113 is thus avoided. It is possible to avoid an additional component in the cell 1, by using a strip 133 formed as one piece with the reinforcement 132 already used.

Seals 23 may be positioned around the gas diffusion layers 21 and 22, in order to guarantee the sealing between the reinforcement 131 and the metal sheet 101 or the sealing between the reinforcement 132 and the metal sheet 102.

The gas diffusion layer 22 is compressed between the cathode 112 and the metal sheet 102. Under this compression, the first and second portions 24 and 25 of the gas diffusion layer 22 have the same thickness, in order to limit the deformations and heterogeneities of the stack of cells 1 and to prevent possible sealing problems at the periphery of the stack. The first and second portions 24 and 25 may have different thicknesses in the absence of compression and be sized as a function of their modulus of elasticity in order to have the same thickness when they are subjected to the compression of the cell 1.

For a compression of 1 MPa after assembly, the portions 24 and 25 advantageously have a thickness of around 190 μm±40 μm.

FIG. 7 illustrates a sequence of several steps of an example of a process for manufacturing one cell 1 of a fuel cell stack 2 according to one embodiment of the invention.

A reinforcement 132 is provided in step 301. The reinforcement 132 is advantageously flat. The reinforcement 132 has for example precut contours corresponding to the openings 134 and 135 to be formed, these contours being separated by the strip 133.

In step 302, an electrocatalytic ink is deposited in the liquid phase, which is intended to form the cathode 112 after drying. The cathode 112 may be solidified by any suitable means. The cathode 112 formed extends beyond the precut contours. Thus, a superposition is created between inner edges of the reinforcement 132 and the periphery of the cathode 112. The anode 111 may be formed in a similar manner on a reinforcement 131 having a precut contour that corresponds to its median opening.

The electrocatalytic material has catalytic properties suitable for the catalytic reaction to be carried out. The electrocatalytic material may be in the form of particles or nanoparticles containing metal atoms. The catalyst material may in particular comprise metal oxides. The electrocatalytic material may be a metal such as platinum, gold, silver, cobalt or ruthenium.

In step 303, a membrane electrode assembly is produced by firmly attaching on one hand the reinforcement 132 and the cathode 112 to one face of a membrane 113, and by firmly attaching on the other hand the reinforcement 131 and the anode 111 to another face of the membrane 113. A reinforcement and an electrode may thus be firmly attached to the membrane 113 during a same hot-pressing step.

In order to promote the adhesion of the electrodes to the membrane 113 during a hot-pressing step, the membrane 113 and the electrodes advantageously comprise the same polymer material. This polymer material advantageously has a glass transition temperature below the hot-pressing temperature. The polymerizable material used to form this polymer material could be the ionomer sold under the commercial reference Nafion DE2020.

In step 304, the portions inside the precut contours of the reinforcements 131 and 132 are removed. The median openings of the reinforcements 131 and 132 are thus made, so as to reveal the respective median portions of the anode 111 and of the cathode 112. Reinforcements were thus formed from supports for the deposition of an electrocatalytic ink.

In step 305, it is possible to form the ducts 124, 125 and 126 by cuts through the periphery of the stacks of layers produced.

In step 306, the gas diffusion layers 21 and 22 are provided. The gas diffusion layer 21 is thus placed in contact with the revealed portion of the anode 111, through the opening of the reinforcement 131. The periphery of the gas diffusion layer 21 covers the inner edge of the reinforcement 131. The portions 24 and 25 of the gas diffusion layer 22 are placed in contact with the revealed portions of the cathode 112, through the openings 134 and 135. The periphery of the gas diffusion layer 22 covers the inner edge of the reinforcement 132.

In step 307, in order to obtain the fuel cell stack cell 1 illustrated in FIG. 5, the membrane electrode assembly provided with the gas diffusion layers 21 and 22 may then be included between two metal flow guide sheets 101 and 102.

1. A fuel cell stack (2), characterized in that it comprises:
a membrane electrode assembly (111, 112, 113) comprising a cathode fastened to a proton exchange membrane;
a conductive plate (102) delimiting a flow channel (106) between an air inlet (125) and a water outlet (126);
a gas diffusion layer (22) covering the flow channel, inserted and compressed between the cathode (112) and the conductive plate (102), the gas diffusion layer (22) comprising first and second portions (24, 25):
being two separate components that adjoin at an interface, and that have adjoining edges of complementary and non-rectilinear shape;
having different compositions;
having a same thickness under said compression;
the composition of the first portion having a current density under dry conditions greater than that of the composition of the second portion;
the composition of the second portion having a current density under wet conditions greater than that of the composition of the first portion;
the first portion extending between 15 and 50% of the length of the flow channel from the air inlet and the second portion extending between 50 and 85% of the length of the channel from the water outlet.

2. The fuel cell stack (2) as claimed in claim 1, comprising a reinforcement (132) fastened to the membrane electrode assembly, the reinforcement (132) comprising:
a first median opening (134) crossed by the first portion (24) of the gas diffusion layer;
a second median opening (135) crossed by the second portion (25) of the gas diffusion layer;
a strip (133) separating the first and second openings and superposed on the interface between the first and second portions of the gas diffusion layer (22).

3. The fuel cell stack (2) as claimed in claim 2, wherein said strip (133) has a width of between 1 and 2 mm.

4. A process for manufacturing a fuel cell stack (2) comprising the steps of:
adjoining first and second portions (24, 25) of a gas diffusion layer (22) having different compositions, the first and second portions (24, 25) being two separate components that adjoin at an interface (26) and that have adjoining edges of complementary and non-rectilinear shape, the composition of the first portion having a current density under dry conditions greater than that of the composition of the second portion, the composition of the second portion having a current density under wet conditions greater than that of the composition of the first portion;
covering a flow channel (106) of a conductive plate (102) with the gas diffusion layer (22), the flow channel extending between an air inlet (125) and a water outlet (126), the first portion extending between 15 and 50% of the length of the flow channel from the air inlet and the second portion extending between 50 and 85% of the length of the channel from the water outlet;
fastening a reinforcement (132) to a membrane electrode assembly prior to the subsequent application of the first and second portions against the cathode of this membrane electrode assembly, the reinforcement (132) comprising a first median opening (134), a second median opening (135) and a strip (133) that separates the first and second median openings;
superposing said interface (26) on said strip (133);
applying the first and second portions (24, 25) against the cathode (112) across the first and second median openings (134, 135) respectively;
compressing the first and second portions (24, 25) of the gas diffusion layer between the conductive plate (102) and the cathode (112) so that the first and second portions have the same thickness.
